(19) United States
(12) Patent Application Publication
(10) Pub. No.: US 2011/0185302 A1
(43) Pub. Date: Jul. 28, 2011

(54) MONITOR FOR UVC/IR DECONTAMINATION SYSTEMS

(76) Inventors: DRAMOS I. KALAPODAS, REXVILLE, NY (US); PAUL E. KALAPODAS, REXVILLE, NY (US)

(21) Appl. No.: 12/967,531

(22) Filed: Dec. 14, 2010

Related U.S. Application Data
(60) Provisional application No. 61/289,199, filed on Dec. 22, 2009.

(51) Int. Cl. G06F 3/048

(52) U.S. Cl. 715/771

(57) ABSTRACT

A Measuring and Monitoring Software Program which is running on a computerized Data Acquisition and Control platform, and which is part of a complete UVC and/or IR disinfection and decontamination systems for air, water or of other physical state of matter. Qualitative and quantitative determination of decontamination efficacy is achieved by means of measuring the air or water quality delivered by system, where UVC and IR radiation intensity is sensed and measured at the lamp surface along with other measurements of air pressure, speed, flow and temperature which are sampled and signal conditioned then processed by the Data Acquisition and Control System (DAQ). These parameters are then sent to the input of the Measuring and Monitoring system where are processed within mathematical routines, and the results are displayed on the computer graphic User Interface (GUI), displaying measurements compared with safety limits, actuator controls, warning and alerts for human interpretation and response.

### CROSS-REFERENCE OR PRIOR KNOWLEDGE

None found in UVC monitoring field.

### STATEMENT

This patent application has not been funded or sponsored by any State or Federal program.

### SEQUENCE LISTING

None provided.

The complete system is being comprised of UVC/IR bio-disinfection modules, multiple sensors as further described, a standard Data Acquisition and Control Interface (DAQ) connected via an USB, Ethernet or other communication port to a computer running the Monitoring and Control application which displays an interactive GUI for human access and intervention. The DAQ to Computer Monitoring program communication is bilateral, thus facilitating a series of controls and actuation to the Disinfection System along with Monitoring functions.

Applications include but are not limited to office or residential buildings, colleges (reducing transmission of contagious diseases), hospitals (eliminates infection and death by staphylococcus bacteria), research centers, ships and airplanes, busses and cars, underground locations as well as individual homes or wherever a closed air and water circulation system is in effect, and where life saving and a decontaminated bio climate is desired in case of accidental or hostile contamination.

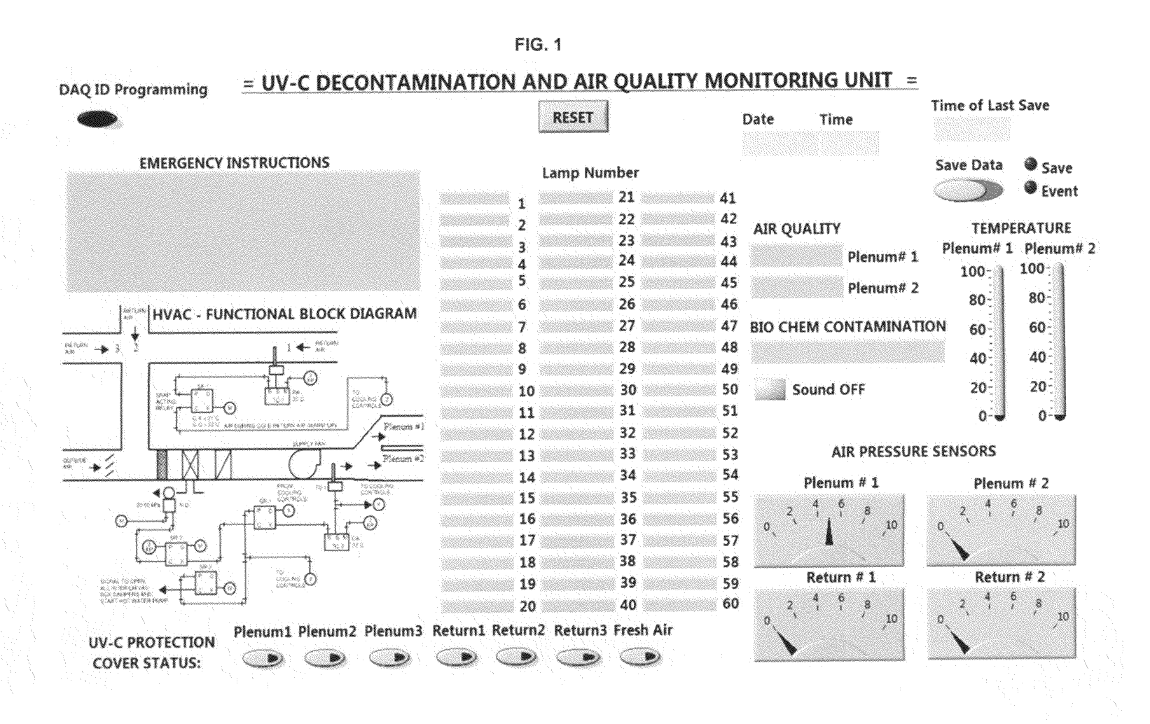

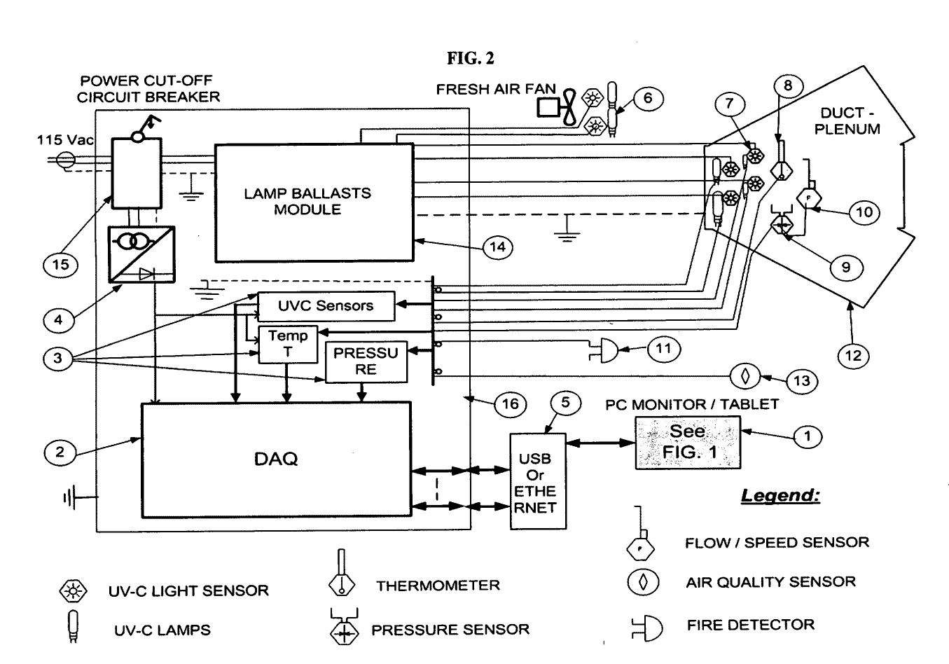

The herein system shown in FIG. 2, being comprised of six UVC lamps, the mentioned sensors, a DAQ with USB connection to a computer running the Monitoring and Control System as shown in FIG. 1, was built and successfully tested in real time conditions.

### BRIEF SUMMARY OF THE INVENTION

The UVC (Ultra Violet rays-C spectrum of 253.7 nm wavelength) along with the Infra Red light (IR, thermal radiation), are well known for their bio decontamination properties. The decontamination effect depreciates in time (a life cycle of approximately 1 to 2 years for Mercury lamps and longer for LED devices) being directly affected by the loss in lamps efficacy (generated radiant intensity per Watt of electricity used) and requires periodic device replacement.

Extended use of such decontamination systems in business and residential buildings, hospitals, maritime ships or aircraft can't guarantee effective environmental disinfection without the presence of measuring, control and monitoring devices. This application does not make any claims on the UVC/IR devices or the Data Acquisition System which are standard equipment.

The herein functional device, a “Monitor for UVC/IR Decontamination System” is a process monitor of an original concept and is part of this patent application for which claims are made. The monitoring system uses an object oriented program designed to analyze the input data through modular routines using proprietary computational methods for the purpose of outputting the results as quantified units on a GUI (Graphical User Interface) for human interpretation, automated response and for generating safety alerts and control functions.

The monitoring system has been designed specifically for UVC (Ultraviolet, C spectrum radiation) and/or IR (Infra-Red radiation) used in the disinfection and decontamination of air, water and/or other liquid, gaseous or solid mediums.

Monitoring the long term decontamination levels represents a mandatory method of verifying the efficiency of any purification unit claiming certain levels of disinfection which otherwise may not be established.

The herein described decontamination system containing UVC/IR lamps, sensors, data acquisition unit and a computerized monitoring instrumentation and control is designed to operate in a closed control loop configuration, unlike the UVC decontamination devices presently marketed for the same final purpose.

### DETAILED DESCRIPTION OF THE INVENTION

The herein system introduces novel computerized monitoring and control features to a decontamination system, and provides a constant interaction at a programmable sampling speed (samples per second) with the sensors used for parameter detection which are further displayed on a VI (Virtual Instrumentation) monitoring screen. Sensors used in the working prototype are listed below;
UV-C Lamp Efficacy sensors and status display
Air/water Quality monitoring with critical level response action to shut down the system, or actuating certain devices if releasing of supplementary bio-chemical neutralizing agents is required.
Pressure monitoring
Temperature measuring
Decontamination system status check
Programmable outputs, analog and digital controls (Boolean response)
Any other specialized bio-chemical sensors demanded by a specific application

Respective parametric signals are received by the data acquisition and control (DAQ) unit from a variety of sensors like UV/IR radiation intensity, temperature, pressure, flow and quality state of the medium, then are mathematically processed by the software where limits are set and displayed on the GUI (FIG. 1) along with warning and alert indicators. Measured values are displayed and periodically stored with a time/date stamp into a log file.

Upon detection of the signals obtained from sensors and actuators, the monitoring system displays the status of the respective parameter in a linear form or Boolean manner and triggers an alert if preset safety limits are exceeded, then visual and audio warning signals are generated to advise in accordance with the parametric violation.

From FIG. 1, the UVC Lamp Efficacy indicators (identified by “Lamp Number” label), Air Quality Sensors, Temperature (Plenum #1, #2), Air Pressure Sensors (Plenum #1, #2 and Return #1, #2), and Hazard Identification (Bio-Chemical Contamination label) display the measurement of their respective sensors in analog format.

The personnel safety during operational and maintenance service of the disinfection unit (labeled HVAC FUNCTIONAL BLOCK DIAGRAM), is guaranteed by switches located under the cover of the respective modules which switches are designed to cut-off the electric power to the modules containing the UVC/IR lamps and their high power circuits. These switches (labeled Plenum1, Plenum2, Plenum3, Return1, Return2, Return3 and Fresh Air Intake) in FIG. 1, provide an ON/OFF condition which is displayed on the monitor as Boolean quantity by changing the color from Green=safe or, Red=danger if the UVC/IR module cover is open.

Other indicators in FIG. 1, are represented by text boxes designated for input or for output of text formatted data (labeled as Date, Time, Time of Last Save and Emergency Instructions). A graphic

Programmable analog and digital control outputs are provided for actuators, in case the system demands the isolation of the contaminating source, or for activating secondary decontamination methods. These controls are triggered by specific threshold levels setup within the analog signals from the Air Quality, Bio-Chemical Contamination and/or the Lamp intensity indicators.

While other present decontamination UVC/IR systems available in the market may be equipped with local lamp indicators for basic functions requiring periodic observation at the lamp location, our application relies on the principles of constant monitoring and control of the life threatening contaminant agents, and consider functional monitoring mandatory for larger disinfection systems containing multiple lamp modules situated at distance from one another (ex., large buildings, vessels, HVAC room etc.) or for units containing lamp which are installed in inaccessible locations.

### Theoretical and Practical Premises Used in the Design

For decades, the germicidal effect of the UV-C rays has been documented and validated by third party tests over a wide range of viral, microbial and mold or spore agents. Odors being generated by bacterial presence are completely deactivated and are effectively removed by exposure to UVC rays. A free Ozone UVC emitter mercury or LED based lamp has its wavelength precisely set at 253.7 nm, which frequency is precisely monitored to prevent negative Ozone effects on people with such sensibilities. The UV-C rays are indisputably an inexpensive, low maintenance and a widely effective disinfection source, when compared to chemical or ionic methods which remain selective in their performance and are linked to health side-effect hazards.

Not all chemical substances are neutralized by the interaction with the UVC light and some may create noxious components, therefore caution is to be exercised in the application and design of the monitoring system which is equipped with air quality sensors for such detection and shut down procedures are programmed within.

Considering the outmost importance of the human safety and the high reliance factor demanded by any bio-chemical decontamination system operating under such complex set of premises, it becomes imperative that strict monitoring principles be implemented within such applications. The lack of clear standardization of the UVC/IR disinfection lamps and considering the importance of human safety which may be guaranteed only by monitoring the performance of a decontamination system, we came to the conclusion that such performance monitoring activity is mandatory for large as well for small systems, which lead us to the present invention.

Therefore, the herein monitor for UVC/IR decontamination system design, relies primarily on information received from Air Quality sensors, and secondarily on the emissive lamp intensity signal which guarantees the air/water quality sought as determining parameters.

A series of operational parameters are analyzed and their measurements are compared with safety thresholds then used to prompt for diverse safety action when the acceptable limits of contamination are exceeded.

Aside these preliminary considerations other quantitative parameters are evaluated in the design of the monitoring program shown in FIG. 1, as it is further described.
a. The UVC energy level E, as a measure of Intensity of the UV-C ray and time, is of the essence in establishing the amounts of radiation necessary for a close to 99% kill rate of the contaminating agents. Where the lamp energy Eₜ=Pt[μWs] is measured at the desired distance considering the necessary kill energy to be effective against a given contaminant agent, which data is given and available from test laboratories.
b. The intensity of the radiation attenuates by an exponential rule in relation to the linear distance from the source. The factory data will refer as a certain energy level per square centimeter at lamp surface or at a given distance of usually 1 m.
c. The exposure time t, in seconds [s] is determinant in the calculation of the system's disinfecting efficacy and is calculated accordingly with the air/water passing speed derived from the CFM (cubic foot per minute) flow capacity information.
d. Distance of the contaminant agent to the UVC/IR emitting source is essential in determining the kill and disinfection efficacy of the system, and is used in calculating the number of emitting sources and their displacement in the system.

For design purpose, the total energy Eₜ, necessary for a specific system is then calculated as a relation of Lamp Energy, the Distance to the contaminant, the Time of exposure to radiation and the Surface to be decontaminated, all relative to the agent's resistance to the radiation which is provided by laboratory studies tabulated accordingly and measured in [μWs cm⁻²].

Therefore, the necessary kill energy per square centimeter for a specific target agent is determined by the formula; Eₜ=Eₗt cm⁻², and is measured in [μWs cm⁻²].

### Hardware System Description

A component description of the DAQ system being implemented, complete with the UVC/IR disinfection unit and sensors used to calibrate and measure the various parameters included in the monitoring system for display and for performance test is shown in FIG. 2., and described below. Circled numbers \textcircled{x} from FIG. 2, are displayed in parenthesis (x) within the context of the description accordingly with the legend below;
\textcircled{1} (1) Monitor for UVC/IR Decontamination System
\textcircled{2} (2) DAQ, Data Acquisition and Control Unit
\textcircled{3} (3) Signal Conditioning Circuits for UVC, Air Speed, Temperature, Flow, Pressure Sensors
\textcircled{4} (4) Power Supply Units for the Electronic Circuits and DAQ
\textcircled{5} (5) USB, Ethernet Communication—Network Hub for multiple DAQs
\textcircled{6} (6) UVC/IR Lamps
\textcircled{7} (7) UVC/IR Intensity Lamp Sensors
\textcircled{8} (8) Temperature Sensor
\textcircled{9} (9) Air Pressure Sensor
\textcircled{10} (10) Air Flow/Speed Sensor
\textcircled{11} (11) Fire/Smoke Detecting Sensor
\textcircled{12} (12) Duct or Plenum Unit
\textcircled{13} (13) Air Quality Sensor
\textcircled{14} (14) UVC/IR Lamp Adjacent Electronic Circuitry
\textcircled{15} (15) Safety Electrical Circuit Separator
\textcircled{16} (16) UVC/IR Decontamination Electric and Control Module

FIG. 2 shows the hardware configuration of the complete system which was built in order to test and verify the main operations of the monitoring system and for testing the VI (Virtual Instrumentation) program modules involved in the calibrations of the measuring and control circuits in this application.

### Functional Description and Operation of the Monitoring Program

The Graphic User Interface of the monitoring system is shown in FIG. 1, where graphical virtual instrumentation is represented on a computer display monitor by objects which are described by their associated title labels.

Note: No numerical component reference is made within FIG. 1, due to the self-explanatory nature of the picture which has the measured parameters' titles written above each text box or control present on the GUI.

Following is the explanation of each virtual instrument and control object as they appear on the monitor's GUI and are depicted in FIG. 1:
DAQ ID Programming; a control button, allowing the entry of coded ID numbers given under password to the data acquisition and control devices and selection of DAQs for computer communication.
EMERGENCY INSTRUCTIONS; a normally hidden Text Box object, displaying an alert or warning message accordingly with the threat encountered, to be used in human evaluation of a response measure.
HVAC—FUNCTIONAL BLOCK DIAGRAM; this display object represents a simplified graphical view of the HVAC system unit, depicting the location of the UV-C lamps in plenums and in air return ducts, and shows the air quality sensors, temperature and air flow transducers.
UV-C PROTECTION COVER STATUS (Plenum 1, 2 and 3, Return 1, 2 and 3, Fresh Air Intake); display objects which indicate the status ON/OFF of the safety switches installed under the UV-C unit as a shut-off protection in case when service is necessary. Each UV-C unit has its respective shut-off switch and indicator and labeled accordingly with its location
UV-C LAMP EFFICACY MONITOR (Lamp Number labels); represent a series of linear quantitative color coded indicators matching the number of UVC lamps installed, and which are programmed to change their color and amplitude (level of box color fill) at three threshold levels set to indicate the efficacy of the UV-C radiation as being, full blue 80-100 [%], yellow for intensity levels between 70 and 80 [%], and red for intensities below 70 [%] which represent an alert for replacement of the respective lamp. Each UV-C lamp has its own detection sensor and efficacy indicator. Labels are marked as (Lamp Number) from 1 to 60 possible lamps in this application. The number of lamps is configurable by disabling the Visible property of the unused display boxes.
AIR QUALITY SENSORS (Plenum #1, and Plenum#2); air quality sensors are situated at certain downstream locations in plenums (the ducts sending air to rooms). To display the contamination levels the signals from the air quality sensor is sent to the data acquisition unit (DAQ) then processed and displayed on the GUI on linear bar indicators where blue is for 100% air purity, lower levels than 90% indicated by a yellow color indicate a contaminated environment, and red is for critical levels of contamination associated with a warning and demand for action by involving new disinfection agents or evacuation which will also trigger an alarm demanding emergency measures to be immediately addressed as displayed on the EMERGENCY INSTRUCTIONS text box.
BIO-CHEMICAL CONTAMINATION; represents a comprehensive indicator of the contamination levels calculated by quantitative risk factored algorithms, processed by its respective VI routine and displayed in accordance with the signals obtained from the air quality sensors indicating the severity of the threat. A sound alarm is then triggered and the Green light to the right of it turns Red thus signifying highly dangerous living conditions and the urgency of immediate measures be taken to save personnel. A control button for Sound Off is also provided for human action.
AIR PRESSURE SENSORS; located in Plenum#1 and #2, and Return#1 and #2, are a number of air flow and pressure sensors indicating if the operating limits of the HVAC unit are maintained within the recommended levels.
TEMPEATURE; temperature sensors located in the Plenum#1, and #2 indicate the air temperature at the input of the plenums necessary to be maintained for proper air quality delivered and for operation of the disinfection unit.
DATE, TIME, TIME OF LAST SAVE; indicates the real date and time and the last time data was logged.
SAVE DATA; Manual saving and logging data to a spreadsheet file as it deems needed. Data is also periodically logged.
STOP or Reset; a reset button that stops and restarts the operation of the program in case of random error, erratic function or computer lock conditions. It brings the settings of the Monitoring System to their default values and clears the last erroneous data stored in memory.
Save, Event; are indicator lamps for the respective functions, showing green when selected.

The operation of the UVC/IR Disinfection Monitoring System is initiated by powering the disinfection unit and all the communication, display and control system.

The DAQ unit(s) is recognized by the monitoring system after its identification code is entered into the virtual instrumentation program by clicking on DAQ/ID Programming button present on the GUI. The DAQ receives conditioned signals with a linear variation in the 0-5V dc or 0-10V dc, from the sensors described before, and also Boolean signals from the safety peripherals, which signals are then placed into a matrix, scanned and distributed by their designation to the virtual instrument inputs where they are compared with previously programmed threshold levels. Upon comparing the measured value with the setup values a coded color and a linear indicator is displayed in the respective box on the GUI for visual reference.

All the sensors are checked for calibration after the initialization occurs or at any time the Reset button is clicked on the GUI.

Decontamination Lamp, radiation intensity data is sent to a three level comparator for color coded output (Blue, Yellow, Red) and is also displayed in a linear manner by the Lamp Number objects located on the GUI.

The Air Quality (for Plenum#1, and Plenum#2) measurements are compared with the internal setup value and will display a Blue color at 100% fill under normal clean air/water or other medium conditions, then at 85% contamination will display a Yellow color with a reduced color fill ratio. If extreme contamination conditions occur, a blinking Red color will appear associated with a sound alert, along with the display of Emergency Instructions and a blinking red location indicator on the HVAC Functional Block Diagram (FIG. 1).

The BIO-CHEMICAL CONTAMINATION indicator follows a specific routine of collecting the outputs from both Air Quality sensors and after comparing and rating them, it will display a color coded contamination alert.

The input from the Temperature sensors (in Plenum#1 and Plenum#2) is processed and scaled into a multiplier for 0 Degrees Fahrenheit to 100 Degrees full scale display.

The Air Pressure sensors (for Plenum#1, and #2 and Return#1, and #2) will display the pressure in the plenums in KPa, in a linear manner, while dangerously low pressure is indicated by a Red color of the display instrument.

For safety during the decontamination unit maintenance, a series of switches are provided under the cover of the UVC/IR decontamination modules, which have the function to disconnect the power to the modules when the cover is removed. The digital signals are processed into a False/True Boolean output and displayed with two color code (Green=cover closed, Red=cover open) on the GUI objects (at Plenum#1, #2, #3 Return#1, #2, #3 and Fresh Air Intake). All parameters and data displayed on the GUI is automatically saved in a spreadsheet format file with a day/time stamp. A manual command to save may be entered by clicking on the Save Data button.

Other analog and digital outputs are made available for special functions and actuation of external emergency containment equipment.

The emitting sources UVC/IR, are monitored for radiation intensity emission and the light flux parameter is received by a proprietary signal conditioner which converts the light intensity sensed at the lamp surface into an electric signal, which signal is then connected to a Data Acquisition and Control unit (DAQ), which in turn sends the data via an USB or Ethernet communication interface to a computer running the monitoring program, as shown in FIG. 2. An HVAC duct (12) is used as the support structure for the installation of the UVC/IR Lamps (6) with ballasts (14), along with their associated light intensity sensors (7) and signal conditioners (3). Adjacent sensors for temperature (8), air flow (10), pressure (9), speed, and air quality (13) are also installed. The signal collected from these sensors is conditioned to reach the necessary voltage level required by the input of the DAQ module (2). A fire/smoke detector (11) is also added for security which triggers a shutdown control output from the monitor.

The power supplies (4) provide electrical energy to the lamps as well as to all electronic circuitry assembled in a modular shielded platform (16). The I/O (Input/Output) data provided by the DAQ (2) is directed via a USB/Ethernet or RS type communication channel to the computerized Monitoring System (1). Multiple DAQ units are connected to the computerized Monitoring System (1) through an USB/Ethernet hub (5) as necessary.

The Monitoring System allows for user programmability to include live video monitoring for security purpose, remote access through the local area network or over the internet, and permits interactive web publishing for access and control.

### BRIEF DESCRIPTION OF THE DRAWINGS

FIG. 1 Graphic User Interface of the Monitoring Software for an UVC/IR Disinfection System
This figure represents the main GUI screen capture of the UVC/IR Monitoring Disinfection System, showing the virtual instrumentation used for measurement, the lamp intensity detection and alerts, date/time, data save, a functional diagram of the HVAC unit monitored, and a field for displaying emergency instructions issued in accordance with the nature of hazard detected.
See page 18 of 19, FIG. 1

FIG. 2 Complete Monitored UVC-Decontamination System, Block Diagram
A block diagram depicting all the hardware components of the disinfection and decontamination system implemented for the herein application.
See page 19 of 19, FIG. 2

1. A functional COMPUTERIZED MONITORING SYSTEM operating within a dedicated computerized hardware platform, integrated into a disinfection equipment unit for air/water or other physical state of matter as it applies but not limited to HVAC units for commercial or residential dwellings, hospitals, naval vessels of all sizes, aircraft, mining industry, human or animal shelters or manufacturing plants; which monitoring system is represented by a Graphic User Interface (GUI) comprised of multiple VIs (virtual instrumentation) and control; which VIs have distributed program functions named here but not limited to; configuration of the DAQ ports, read the analog inputs and display the data for Air Quality, detect the presence of bio-chemical hazard in plenums and return ducts with color coded display (green for safe, yellow and red for extreme contamination levels indication); measure and display UVC/IR lamp efficacy status, air pressure, temperature and flow; perform medium quality measurements and issue alerts; display the comfort level for safety and compute contamination levels; identify the threat location; which system is being ran by a computer program used for processing of data obtained from various sensors which are connected to a Data Acquisition and Control unit (DAQ) by means of standard communication and also including user programmable utilities for intranet, internet communication or access through web applications.

2. The system in claim 1, wherein the PROCESS claimed is based on functions performed by an object oriented computer software code comprised of preexisting object code modules is implied for the development of an original and novel method of sensing, measurement, processing of data and displaying information obtained from the said system; which software is having operating attributes to perform communication with DAQ; data formatting and mapping, mathematical computation, logic structure manipulation, encoding/decoding, digital and analog processing, timing and file management; display results onto a computer monitor screen; perform signal analysis, and processing where the electric signals received from multiple sensors and data packets are mathematically and logically processed; an object oriented computer code built in association with and specific to the disinfection/decontamination method as suited for the decontamination apparatus containing various disinfection emitting sources as described in claim 1.

3. The system in claim 1, where a DISPLAY unit functions are represented by a Computer Graphic User Interface (GUI) built to display parametric signals from sensors, graphically show measured and compared signal quantities against internal programmable reference levels setup for alert and control; display processed data to satisfy conditions set by signal analysis algorithms; show comparative results against stored mapped references; generate linear and quantized output to virtual graphical instrumentation for parametric measurement and alert displays in the GUI; enable/disable various on screen controls for safety devices actuation; display alert indicators by quantity and by a color coded output against internally set references; trigger sound alarms; display warnings and evacuation instructions in a text box accordingly with previously entered data per local safety codes; perform data logging and information retrieving; and all but not exclusive to, other programmable functions dedicated to the operation of the disinfection apparatus in a remote environment.
